(19) United States
(12) Patent Application Publication
(10) Pub. No.: US 2026/0342191 A1
(43) Pub. Date: Oct. 29, 2026

(54) Vibration Motor

(71) Applicant: AAC Microtech (Changzhou) Co., Ltd., Changzhou City (CN)

(72) Inventors: Lubin Mao, Changzhou (CN); Wei Song, Changzhou (CN); Yun Tang, Changzhou (CN); Zhiyong Cui, Changzhou (CN)

(21) Appl. No.: 19/305,741

(22) Filed: Aug. 20, 2025

Related U.S. Application Data
(63) Continuation of application No. PCT/CN2025/091980, filed on Apr. 29, 2025.

(51) Int. Cl. H02K 33/02

(52) U.S. Cl. CPC H02K 33/02

(57) ABSTRACT

The present invention provides a vibration motor including a housing having a receiving room, a stator accommodated in the receiving room, a vibrator providing vibration sensation, and at least one elastic connector suspending the vibrator in the receiving room. The stator includes a circuit board and a coil. A winding plane of the coil is parallel to a vibration direction of the vibrator. The housing is provided with at least one through hole corresponding to a position of the coil to avoid the coil. The coil extends at least partially within the through hole. The vibration motor of the present invention is equipped with a through hole on the housing to allow the coil to be embedded in the housing in a height direction, which can effectively increase the effective straight edge length of the coil and thus improve the driving force.

### FIELD OF THE PRESENT INVENTION

The present invention relates to the field of vibration motor, and more particularly, to a vibration motor with coil as the stator structure.

### DESCRIPTION OF RELATED ART

Vibration motors are the device that directly convert electrical energy into mechanical energy for linear motion. Vibration motors are widely used in various devices that require linear motion.

In related art, in vibration motor technology, a conventional vibration motor usually includes a housing, a vibrator, and a stator. The stator includes a coil. The vibrator is suspended in the housing by a spring support, and the coil is welded and fixed to the circuit board. The coil is generally completely contained in the containment space formed by the housing. In this type of vibration motor structure, the effective length of the coil is limited to a certain extent. Even when the maximum effective length of the coil has been reached, there may still have a problem of insufficient driving force.

Therefore, it is desired to provide a new vibration motor which can overcome the above problems.

### SUMMARY

In view of the above, the embodiments of the present invention provide a new vibration motor with significantly increased driving force under a certain size.

The present invention provides a vibration motor including a housing having a receiving room, a stator accommodated in the receiving room, a vibrator providing vibration sensation, and at least one elastic connector connected to the housing and suspending the vibrator in the receiving room. The housing includes a bottom cover and an upper cover enclosing the receiving room with the bottom cover. The stator includes a circuit board mounted on the bottom cover and a coil electrically connecting to the circuit board. A winding plane of the coil is parallel to a vibration direction of the vibrator. The housing is provided with at least one through hole corresponding to a position of the coil to avoid the coil. The coil extends at least partially within the through hole.

As an improvement, the upper cover or the bottom cover is provided with the through hole.

As an improvement, both the upper cover and the bottom cover are provided with the through holes.

As an improvement, the stator further includes a supporting member supporting the coil, the coil including a first end and a second end along a direction perpendicular to the vibration direction of the vibrator, the first end and/or the second end partially extending within the through hole, the supporting member including a first fixed portion connected to the upper cover, a second fixed portion connected to the bottom cover, a first joint portion bending from the first fixed portion and fixedly connected to the first end of the coil, a second joint portion bending from the second fixed portion and fixedly connected to the second end of the coil, and a connection portion connecting the first joint portion and the second joint portion.

As an improvement, the coil is wound to form a central through hole, and the connection portion is located inside the central through hole.

As an improvement, the first fixed portion is welded and fixed to the upper cover, and the second fixed portion is welded and fixed to the bottom cover.

As an improvement, the first joint portion is glued and fixed to the first end of the coil, and the second joint portion is glued and fixed to the second end of the coil.

As an improvement, an outer surface of the coil extending into the through hole is flush with an outer surface of the housing.

As an improvement, the vibrator includes a weight having a penetrating hole and a magnet assembly fixed in the penetrating hole, the magnet assembly extending along the vibration direction of the vibrator and arranged on both sides of the coil.

As an improvement, there are two groups of the magnet assemblies, each group of the magnet assembly including a magnet and a pole plate sandwiched between the magnet and the weight, one of the magnets including a protruding part facing the connection portion of the supporting member.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a vibration motor in accordance with the present invention.

FIG. 2 is a partially exploded view of the vibration motor of FIG. 1.

FIG. 3 is another partially exploded view of the vibration motor of FIG. 1.

FIG. 4 is an exploded view of the vibration motor of FIG. 1.

FIG. 5 is an exploded view of the vibration motor of FIG. 1 from another perspective.

FIG. 6 is an illustrative cross-sectional view of the vibration motor taken along line A-A of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

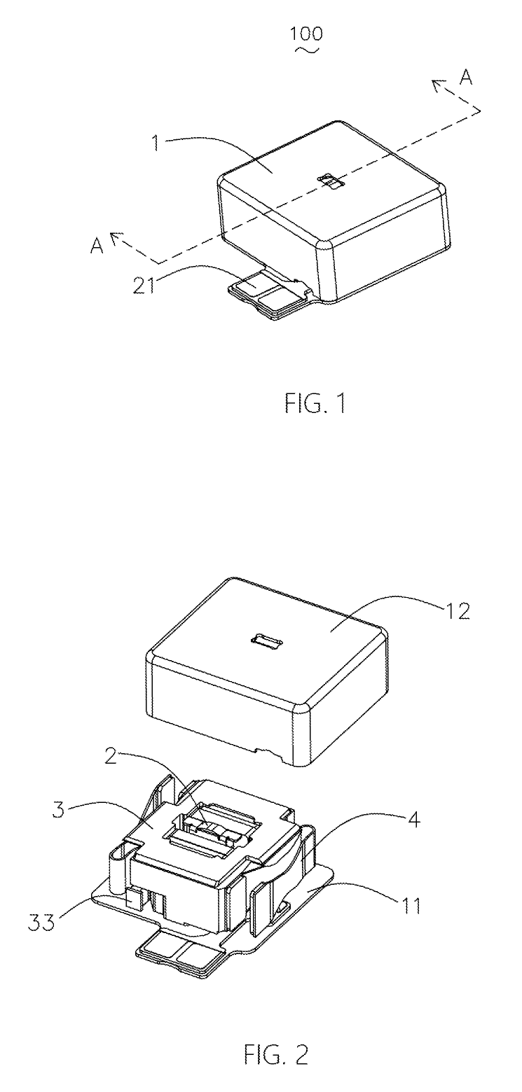

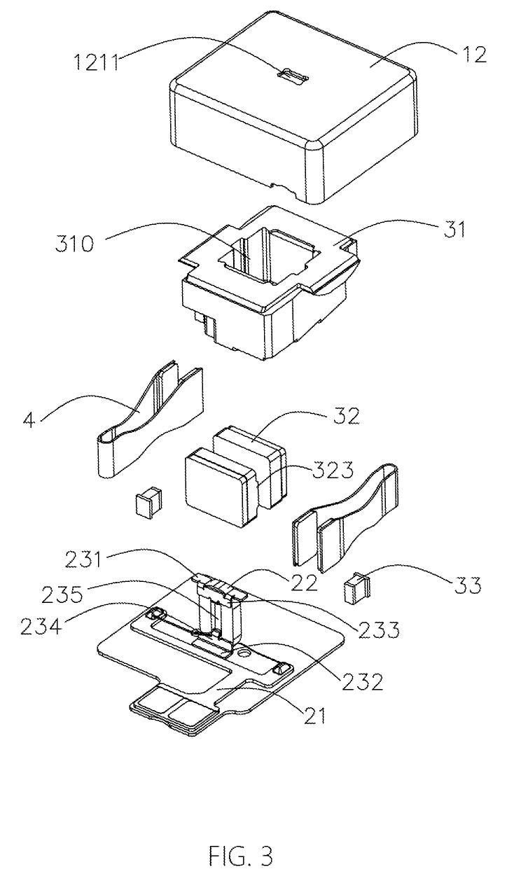

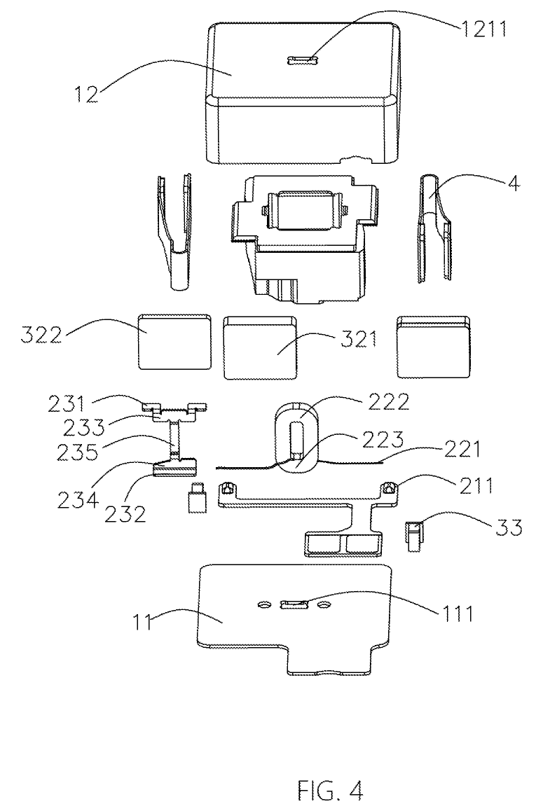

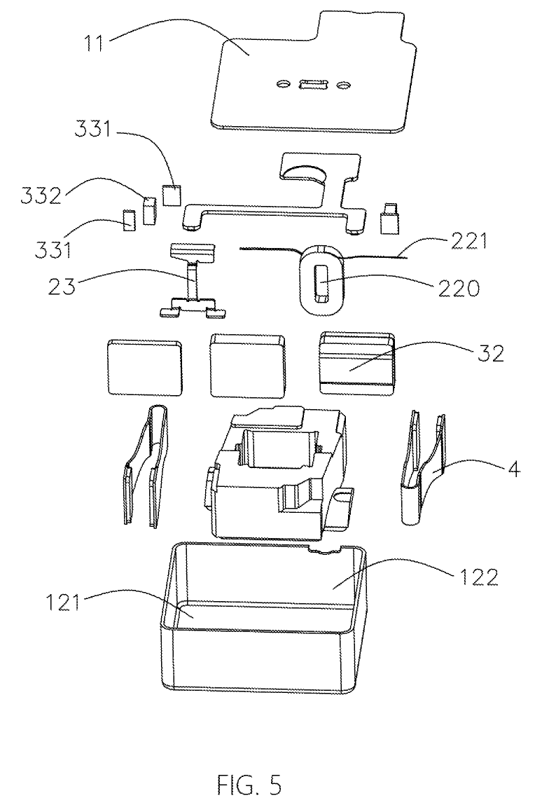

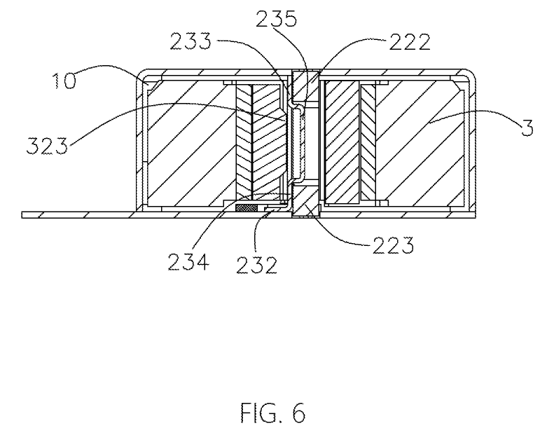

Referring to the FIGS. 1-6, the present invention provides a vibration motor 100 including a housing 1 having a receiving room 10, a stator 2 accommodated in the receiving room 10, a vibrator 3 providing vibration sensation, and at least one elastic connector 4 connected to the housing 1 and suspending the vibrator 3 in the receiving room 10.

The housing 1 is made of metal material. The housing 1 includes a bottom cover 11 and an upper cover 12 enclosing the receiving room 10 with the bottom cover 11. The bottom cover 11 is a plate-shaped structure, and the bottom cover 11 is provided with a through hole 111. The upper cover 12 includes a top wall 121 and a side wall 122 bending downward from the top wall 121, and the top wall 121 is provided with a through hole 1211. In other embodiments, the through hole 1211 can be only set on the upper cover 12 or the through hole 111 can be only set on the bottom cover 11 according to demand. The through hole is substantially with a rectangular shape. The bottom cover 11 includes a positioning hole at both sides of the through hole 111 for assembly.

The stator 2 includes a circuit board 21 mounted on the bottom cover 11, a coil 22 electrically connecting to the circuit board 21 and a supporting member 23 supporting the coil 22. The circuit board 21 has a plurality of soldering pads 211. The circuit board 21 partially extends out of the housing 1. The coil 22 is fixed on the circuit board 21. The circuit board 21 is electrically connected to the coil 22 to apply an alternating current to coil 22.

The coil 22 is wound to form a central through hole 220. A winding plane of the coil 22 is parallel to a vibration direction of the vibrator 6. That is, the coil 22 is installed inside the housing 1 vertically. The coil 22 includes a pair of leading wires 221, and the leading wires 221 are welded and fixed to the soldering pads 211 of the circuit board 21. The coil 22 extends at least partially within the through hole of the housing 1. Specifically, the coil 22 includes a first end 222 and a second end 223 along a direction perpendicular to the vibration direction of the vibrator 3. The first end 222 partially extends within the through hole 1211 of the upper cover 12, and the second end 223 partially extends within the through hole 111 of the bottom cover 11. In this embodiment, both the upper cover 12 and the bottom cover 11 are provided with through holes. The through holes avoids the coil 22 and allow the coil 22 to be partially embedded in the housing 1 in a height direction. It effectively increases an effective straight edge length of the coil 22 and thereby improving the driving force of the vibration motor 100. Optionally, an outer surface of the coil 22 extending into the through hole is flush with an outer surface of the housing 1. It can be understood that the through hole can be replaced with a blind hole, which only needs to provide some avoidance space for the coil 22.

The supporting member 23 includes a first fixed portion 231 connected to the upper cover 12, a second fixed portion 232 connected to the bottom cover 11, a first joint portion 233 bending from the first fixed portion 231 and fixedly connected to the first end 222 of the coil 22, a second joint portion 234 bending from the second fixed portion 232 and fixedly connected to the second end 223 of the coil 22, and a connection portion 235 connecting the first joint portion 233 and the second joint portion 234. The connection portion 235 is located inside the central through hole 220. The first fixed portion 231 is welded and fixed to the upper cover 12, and the second fixed portion 232 is welded and fixed to the bottom cover 11. The first fixed portion 231 and the second fixed portion 232 both extend along a horizontal plane. The first joint portion 233 is glued and fixed to the first end 222 of the coil 22, and the second joint portion 234 is glued and fixed to the second end 223 of the coil 22. Both the first joint portion 233 and the second joint portion 234 extend in a vertical direction, that is, extend along the winding plane of the coil 22.

The vibrator 3 is suspended in the housing 1 by the elastic connectors 4. The vibrator 3 vibrates horizontally in the left-right direction to make the vibration motor 100 provide vibration sensation. The vibrator 3 includes a weight 31 having a penetrating hole 310 and a magnet assembly 32 fixed in the penetrating hole 310. The magnet assembly 32 extends along the vibration direction of the vibrator 3 and arranged on both sides of the coil 22. There are two groups of the magnet assemblies 32, and each group of the magnet assembly 32 includes a magnet 321 and a pole plate 322 sandwiched between the magnet 321 and the weight 31. One of the magnets 321 includes a protruding part 323 facing the connection portion 235 of the supporting member 23. The protruding part 323 can effectively increase a volume of the magnet 321, reduce a size of the magnetic gap, and increase a magnetic field strength of the magnet assembly 32. The vibrator 3 further includes a damping element 33 located on each side of the weight 31 along the vibration direction of the vibrator 3. The damping element 33 includes two iron sheets 331 and a silicone gel 332 clamped between the two iron sheets 331. The damping element 33 is fixed to the weight 31 by gluing or welding.

The coil 22 is applied with the alternating current, and the coil 22 cuts the magnetic induction line of the magnet assembly 32 and generates induced electromotive force, which causing the magnet assembly 32 and the fixed weight 31 to vibrate in the left-right direction to make the vibration motor 100 provide vibration sensation.

The elastic connector 4 elastically supports the vibrator 3. One end of the elastic connector 4 is connected to the weight 31, and the other end of the elastic connector 4 is connected to the housing 1, which providing elastic recovery force to the vibrator 3. The elastic connector 4 is a V-shaped spring piece, and in this embodiment, the number of elastic connectors 4 is two.

Comparing with the related art, the present invention provides a vibration motor including a housing having a receiving room, a stator accommodated in the receiving room, a vibrator providing vibration sensation, and at least one elastic connector connected to the housing and suspending the vibrator in the receiving room. The housing includes a bottom cover and an upper cover enclosing the receiving room with the bottom cover. The stator includes a circuit board mounted on the bottom cover and a coil electrically connecting to the circuit board. A winding plane of the coil is parallel to a vibration direction of the vibrator. The housing is provided with at least one through hole corresponding to a position of the coil to avoid the coil. The coil extends at least partially within the through hole. The vibration motor of the present invention is equipped with at least one through hole on the housing to avoid the coil and make the coil to be embedded in the housing in a height direction, which can effectively increase the effective straight edge length of the coil and thus improve the driving force.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration motor, comprising:
a housing having a receiving room, the housing comprising a bottom cover and an upper cover enclosing the receiving room with the bottom cover;
a stator accommodated in the receiving room, the stator comprising a circuit board mounted on the bottom cover and a coil electrically connecting to the circuit board;
a vibrator providing vibration sensation; and
at least one elastic connector connected to the housing and suspending the vibrator in the receiving room;
wherein a winding plane of the coil is parallel to a vibration direction of the vibrator, the housing provided with at least one through hole corresponding to a position of the coil to avoid the coil, and the coil extending at least partially within the through hole.

2. The vibration motor as described in claim 1, wherein the upper cover or the bottom cover is provided with the through hole.

3. The vibration motor as described in claim 1, wherein both the upper cover and the bottom cover are provided with the through holes.

4. The vibration motor as described in claim 1, wherein the stator further comprises a supporting member supporting the coil, the coil comprising a first end and a second end along a direction perpendicular to the vibration direction of the vibrator, the first end and/or the second end partially extending within the through hole, the supporting member comprising a first fixed portion connected to the upper cover, a second fixed portion connected to the bottom cover, a first joint portion bending from the first fixed portion and fixedly connected to the first end of the coil, a second joint portion bending from the second fixed portion and fixedly connected to the second end of the coil, and a connection portion connecting the first joint portion and the second joint portion.

5. The vibration motor as described in claim 4, wherein the coil is wound to form a central through hole, and the connection portion is located inside the central through hole.

6. The vibration motor as described in claim 4, wherein the first fixed portion is welded and fixed to the upper cover, and the second fixed portion is welded and fixed to the bottom cover.

7. The vibration motor as described in claim 4, wherein the first joint portion is glued and fixed to the first end of the coil, and the second joint portion is glued and fixed to the second end of the coil.

8. The vibration motor as described in claim 1, wherein an outer surface of the coil extending into the through hole is flush with an outer surface of the housing.

9. The vibration motor as described in claim 4, wherein the vibrator comprises a weight having a penetrating hole and a magnet assembly fixed in the penetrating hole, the magnet assembly extending along the vibration direction of the vibrator and arranged on both sides of the coil.

10. The vibration motor as described in claim 9, wherein there are two groups of the magnet assemblies, each group of the magnet assembly comprising a magnet and a pole plate sandwiched between the magnet and the weight, one of the magnets comprising a protruding part facing the connection portion of the supporting member.
